(19) United States
(12) Patent Application Publication
(10) Pub. No.: US 2007/0234170 A1
(43) Pub. Date: Oct. 4, 2007

(54) Method and system for communication of video information over wireless channels

(75) Inventors: Huai-Rong Shao, San Jose, CA (US); Harkirat Singh, Santa Clara, CA (US); Pengfei Xia, Mountain View, CA (US); Chiu Ngo, San Francisco, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/728,009

(22) Filed: Mar. 22, 2007

Related U.S. Application Data
(60) Provisional application No. 60/787,344, filed on Mar. 29, 2006.

(51) Int. Cl. H04L 1/00; H04N 7/173

(52) U.S. Cl. 714/746

(57) ABSTRACT

A method and system for transmitting video information from a sender to a receiver over a wireless channel is provided. Video information bits are placed into one or more data packets at the sender, and each data packet is transmitted from the sender to the receiver over a wireless channel during a current time frame. For each transmitted data packet, the sender receives a corresponding acknowledgment packet from the receiver. The sender then performs burst retransmission of the negatively acknowledged packets during a next time frame comprising a BeamTrack Group for transmission of further data packets from the sender to the receiver over a wireless channel. The receiver utilizes each retransmitted data packet to recover a lost or erroneously received data packet.

### RELATED APPLICATION

This application claims priority from U.S. Provisional Patent Application Ser. No. 60/787,344, filed on Mar. 29, 2006, incorporated herein by reference.

### FIELD OF THE INVENTION

The present invention relates to wireless transmission of video information and in particular, to transmission of uncompressed high-definition video information over wireless channels.

### BACKGROUND OF THE INVENTION

With the proliferation of high quality video, an increasing number of electronics devices (e.g., consumer electronics (CE) devices) utilize high-definition (HD) video which can require multiple gigabit per second (Gbps) in bandwidth for transmission. As such, when transmitting such HD video between devices, conventional transmission approaches compress the HD video to a fraction of its size to lower the required transmission bandwidth. The compressed video is then decompressed for consumption. However, with each compression and subsequent decompression of the video data, some data can be lost and the picture quality can be reduced.

The High-Definition Multimedia Interface (HDMI) specification allows transfer of uncompressed HD signals between devices via a cable. While consumer electronics makers are beginning to offer HDMI-compatible equipment, there is not yet a suitable wireless (e.g., radio frequency) technology that is capable of transmitting uncompressed HD video signals. Wireless local area network (WLAN) and similar technologies can suffer interference issues when several devices are connected which do not have the bandwidth to carry the uncompressed HD signal, and do not provide an air interface to transmit uncompressed video over 60 GHz band. There is, therefore, a need for a method and system for wireless transmission of video information which addresses the above shortcomings.

### BRIEF SUMMARY OF THE INVENTION

The present invention provides a method and system for communication of video over a wireless channel from a sender to a receiver. In one embodiment, video information bits are placed into one or more data packets at the sender, and each data packet is transmitted from the sender to the receiver over a wireless channel during a current time frame. For each transmitted data packet, the sender receives a corresponding acknowledgment packet from the receiver. The sender then performs burst retransmission of the negatively acknowledged packets during a next time frame comprising a BeamTrack Group for transmission of further data packets from the sender to the receiver over a wireless channel. The receiver utilizes each retransmitted data packet to recover a lost or erroneously received data packet.

In another embodiment, performing burst retransmission of the data packets further includes delaying retransmission of the data packets with negative acknowledgments until said next time frame, and then retransmitting said data packets with negative acknowledgments at the beginning of said next time frame in a burst sequence. The sender can place a copy of each transmitted data packet in a retransmission buffer. For each transmitted data packet, the receiver sends a corresponding acknowledgment packet from the receiver, wherein each acknowledgment packet includes a positive acknowledgement if a corresponding data packet was received without errors or a negative acknowledgement if a corresponding data packet was lost or arrived at the receiver with errors. The sender removes the data packets with positive acknowledgments from the retransmission buffer, and delays retransmission of the data packets remaining in the retransmission buffer until a next time frame for transmission of multiple data packets from the sender to the receiver. During said next time frame, the sender retransmits the data packets from the retransmission buffer to the receiver in a burst sequence over a wireless channel. Preferably, the current time frame comprises a current beamtracking period, and the next time frame comprises a next beamtracking period.

In another embodiment, the sender can place a copy of each transmitted data packet with a negative acknowledgment in a retransmission buffer, and delay retransmission of the data packets in the retransmission buffer until a next time frame for transmission of multiple data packets from the sender to the receiver. Then, during said next time frame, the sender retransmits the data packets from the retransmission buffer to the receiver over a wireless channel.

These and other features, aspects and advantages of the present invention will become understood with reference to the following description, appended claims and accompanying figures.

### BRIEF DESCRIPTION OF THE DRAWINGS

FIG. 1 shows a functional block diagram of an example wireless network that implements uncompressed HD video transmission between wireless devices using a retransmission scheme, according to the present invention.

FIG. 2 shows an example timeline for packet transmission over high-rate and low-rate wireless channels using Time Division Duplex (TDD) scheduling.

FIG. 3 shows an example timeline for transmission of data packets from a sender to a receiver and immediate retransmission of a data packet if it is lost or arrives at the receiver with errors.

FIG. 4 shows an example timeline for transmission of data packets from a sender to a receiver in the network of FIG. 1 during a current BeamTrack Group time period, and retransmission of a lost or erroneous data packet in a next BeamTrack Group time period, according to the present invention.

FIG. 5 shows an example functional block diagram of a wireless sender in the network of FIG. 1 operating according to the transmission timeline in FIG. 4, according to the present invention.

FIG. 6 shows an example functional block diagram of a wireless receiver in the network of FIG. 1, operating according to the transmission timeline in FIG. 4, according to the present invention.

FIG. 7 shows a flowchart of a transmission scheduling and buffer management process at a wireless sender in the network of FIG. 1, according to the present invention.

FIG. 8 shows a flowchart of a receiving process at a wireless receiver in the network of FIG. 1, according to an embodiment of the present invention.

FIG. 9 shows a functional block diagram of another wireless network that implements uncompressed HD video transmission between wireless stations, according to an embodiment of the present invention.

### DETAILED DESCRIPTION OF THE INVENTION

The present invention provides a method and system for communication of video information over wireless channels, comprising wireless transmission and retransmission of video information such as uncompressed HD video information from a sender to a receiver. According to an embodiment of the present invention, a burst retransmission of data packets is performed for a fading channel in which packet loss may occur. This improves the transmission reliability and also satisfies delay jitter and buffer size requirements at the receiver.

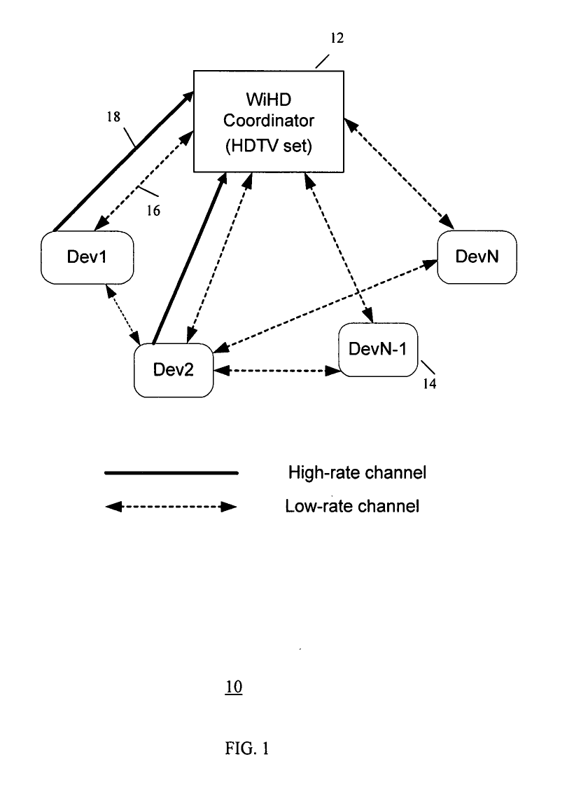

Example implementations of the embodiments of the present invention in a wireless HD (WiHD) system are now described. FIG. 1 shows a functional block diagram of a wireless network 10 that implements uncompressed HD video transmission between WiHD devices such as a WiHD coordinator and WiHD stations, according to an embodiment of the present invention. The network 10 includes a WiHD coordinator 12 and multiple WiHD stations 14 (e.g., Dev1, . . . , DevN).

The WiHD stations 14 utilize a low-rate wireless channel 16 (dashed lines in FIG. 1), and may use a high-rate channel 18 (heavy solid lines in FIG. 1), for communication therebetween. The WiHD coordinator 12 uses a low-rate channel 16 and a high-rate wireless channel 18, for communication with the stations 14. Each station 14 uses the low-rate channel 16 for communications with other stations 14. The high-rate channel 18 only supports single direction unicast transmission over directional beams established by beamforming, with, e.g., multi-Gb/s bandwidth to support uncompressed HD video transmission. The low-rate channel 16 can support bi-directional transmission, e.g., with at most 40 Mbps (megabits per second) throughput. The low-rate channel 16 is mainly used to transmit control frames such as acknowledgement (ACK) frames.

In this example, the WiHD coordinator 12 is a sink of video information (hereinafter “receiver 12”), and a WiHD station 14 is a sender of the video information (hereinafter “sender 14”). For example, the receiver 12 can be a sink of video and/or audio data implemented, e.g., in a HDTV set in a wireless network environment. The sender 14 can be a source of uncompressed video or audio. Examples of the sender include a set-top box, a DVD player, etc. In another example, the coordinator 12 can be a source of a video stream. In yet another example, the coordinator provides channel coordination functions for wireless communication between a sink station and a source station. The coordinator functions such as channel access functions according to the present invention can also be implemented in a stand-alone device, in a sink device and/or in a source device.

In many wireless communication systems, a frame structure is used for data transmission between a transmitter and a receiver. For example, the IEEE 802.11 standard uses frame aggregation in a Media Access Control (MAC) layer and a physical (PHY) layer. In a typical transmitter, a MAC layer receives a MAC Service Data Unit (MSDU) and attaches a MAC header thereto, in order to construct a MAC Protocol Data Unit (MPDU). The MAC header includes information such a source addresses (SA) and a destination address (DA). The MPDU is a part of a PHY Service Data Unit (PSDU) and is transferred to a PHY layer in the transmitter to attach a PHY header (i.e., PHY preamble) thereto to construct a PHY Protocol Data Unit (PPDU). The PHY header includes parameters for determining a transmission scheme including a coding/modulation scheme. Before transmission as a packet from a transmitter to a receiver, a preamble is attached to the PPDU, wherein the preamble can include channel estimation and synchronization information.

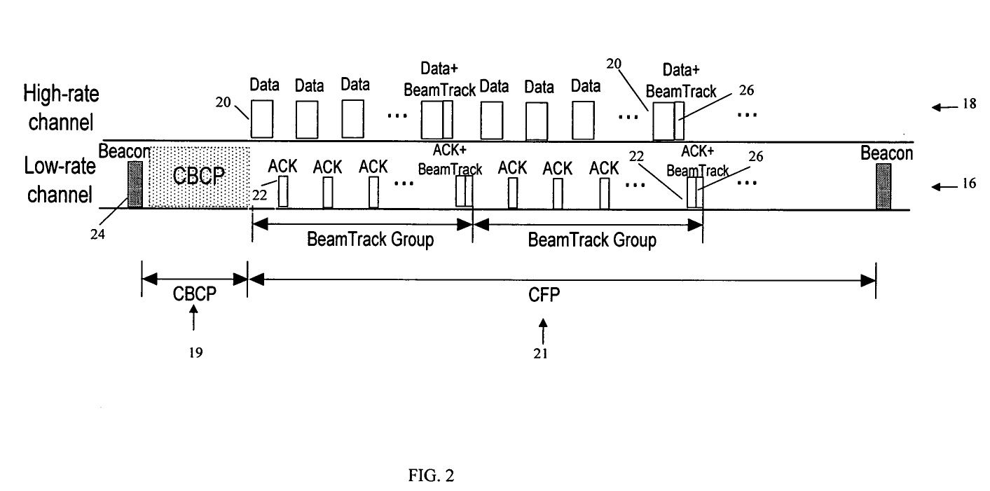

As shown by the example information transmission timeline in FIG. 2 according to the present invention, the sender 14 transmits data packets 20 that carry payloads of uncompressed video information bits, to the receiver 12 over the high-rate channel 18. After a contention-based control period (CBCP) 19, the data packets 20 are transmitted to the receiver 12 over the shared channel 18 in a contention-free period (CFP) 21. After receiving each data packet 20, the receiver 12 transmits a corresponding ACK packet 22 to the sender 14 over the shared channel 16 in a CFP 21.

As shown in FIG. 2, TDD scheduling is applied to the low-rate channel 16 and the high-rate channel 18, whereby at any one time the low-rate and high-rate channels 16 and 18 cannot be used in parallel for transmission. For example, the Beacon packets 24 and ACK packets 22 are transmitted over the low-rate channel 16 in between transmission of data packets 20 (e.g., video, audio and control message) information over the high-rate channel 18. In another example, Frequency Division Duplex (FDD) scheduling can be used.

Each Beacon 24 is used to set timing allocations and to communicate management information for the network 10. Control and Management information can be transmitted in the CBCP. After a Beacon 24 and a CBCP, transmission of the data packets 20 and corresponding ACK packets 22 begins. Each data packet 20 and corresponding ACK packet form a data-ACK pair.

Further, as shown in FIG. 2, beamtracking information 26 is piggybacked to selected data packets 20 and to corresponding ACK packets 22. Piggybacking of the beamtracking information is performed periodically, such as once per every 5˜10 data packet-ACK pairs. The beamtracking information is piggybacked with video data information periodically to maintain beamforming transmission quality. Such beamtracking information is used to fine-tune the beamforming parameters at both the sender 14 and the receiver 12 to keep good link quality, since wireless links dynamically change by different factors such as environmental factors.

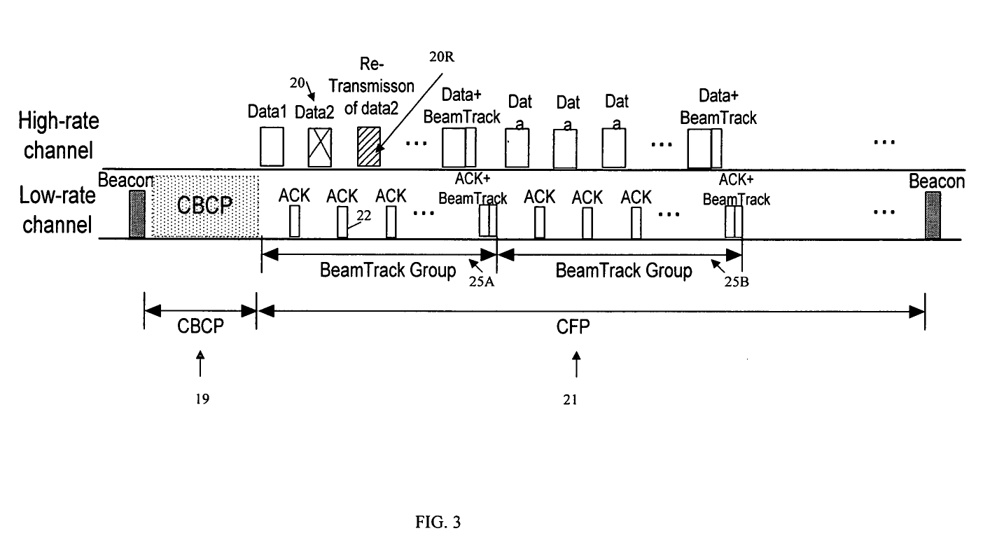

Beamtracking updating frequency can be decided according to channel coherence time. One empirical formula for the channel coherence time is 0.423/fm where fm=v*f/c where v is the velocity in m/s, f is the carrier frequency in Hz (60 gigabits for WiHD) and c is 3*10⁸. For example, if v is 3 meters per second, then coherence time is 705 μs long. If one data packet is 100 μs long (i.e., it takes 100 μs to transmit and receive an ACK for), then there are about 7 data-ACK pairs within the coherence time as one beamtracking group time period (BeamTrack Group). If one data packet is lost, then other data packets within the coherence time have a high probability of loss as well. The example in FIG. 3 shows transmission of a data packet data2 (i.e., packet 20 marked “X”) in a BeamTrack Group 25A, reception of a corresponding negative ACK packet 22 that indicates the data packet 20 arrived at the receiver with errors, and retransmission of the data packet data2 (i.e., packet 20R marked with cross-hatching), immediately after receiving the negative ACK packet 22 within the same BeamTrack Group 25A. In this case, the probability of loss for the retransmitted data packet 20R is very high due to channel coherence characteristics (i.e., within the same BeamTrack Group 25A).

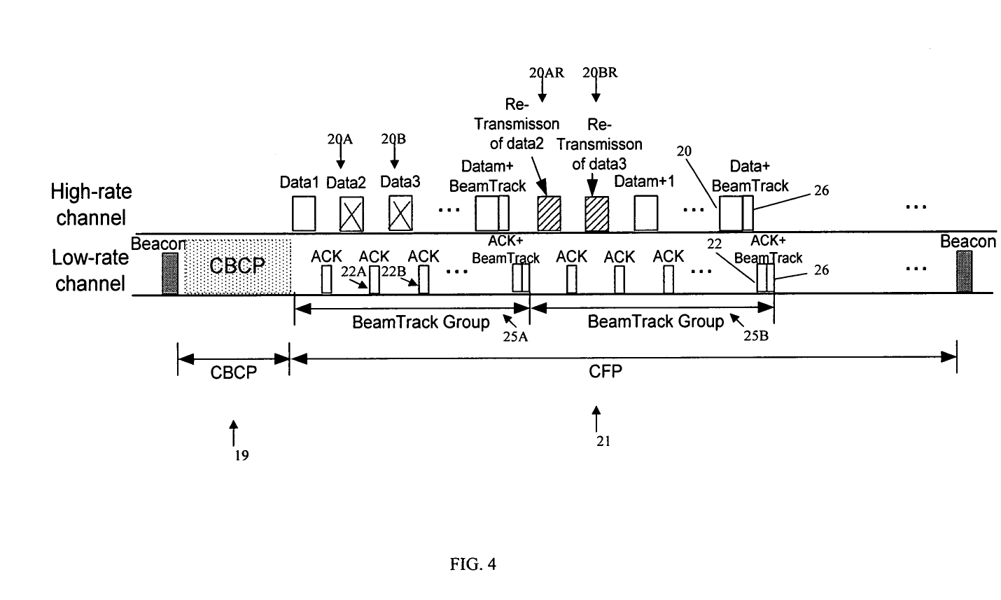

According to the example timeline in FIG. 4, retransmission of a lost data packet is performed in the next BeamTrack Group 25B, instead of within the same BeamTrack Group 25A. Specifically, in FIG. 4, data packets 20A and 20B are transmitted from the sender 14 to the receiver 12 in the BeamTrack Group 25A. The corresponding ACK packets 22A and 22B, respectively, from the receiver 12 indicate that the data packets 20A and 20B, arrived at the receiver with errors or were lost. Instead of retransmitting the lost or erroneous data packets in the same BeamTrack Group 25A, adaptive retransmission is utilized wherein the original data packets corresponding to the lost or erroneous data packet are collected (e.g., placed in a retransmission buffer), and then retransmitted in a burst sequence by the sender 14 as packets 20AR and 20BR in the following BeamTrack Group 25B, according to an embodiment of the present invention. As such, retransmission of the data packets 20A and 20B is delayed until the following (i.e., next) BeamTrack Group 25B.

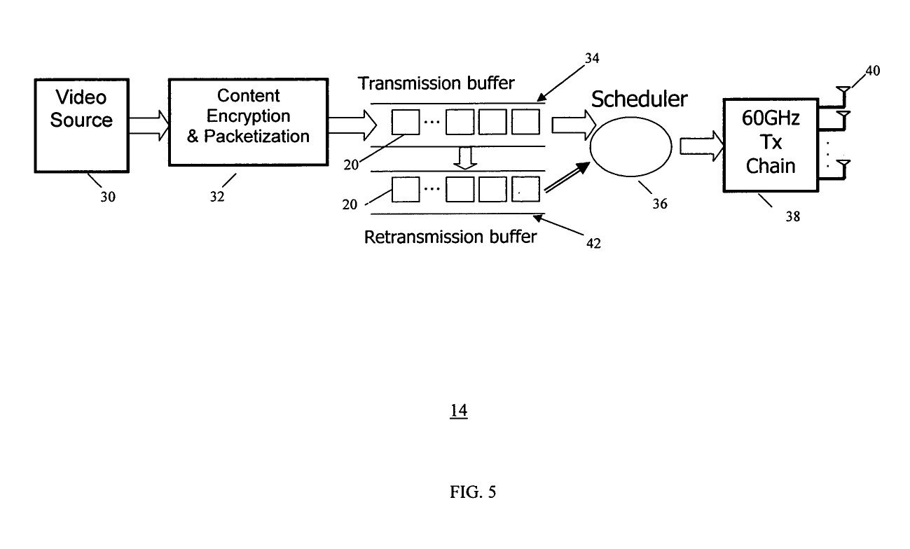

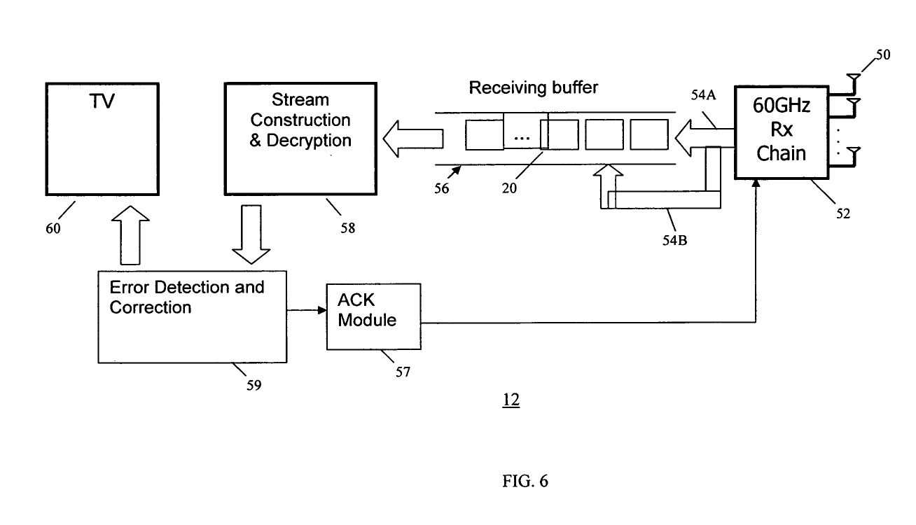

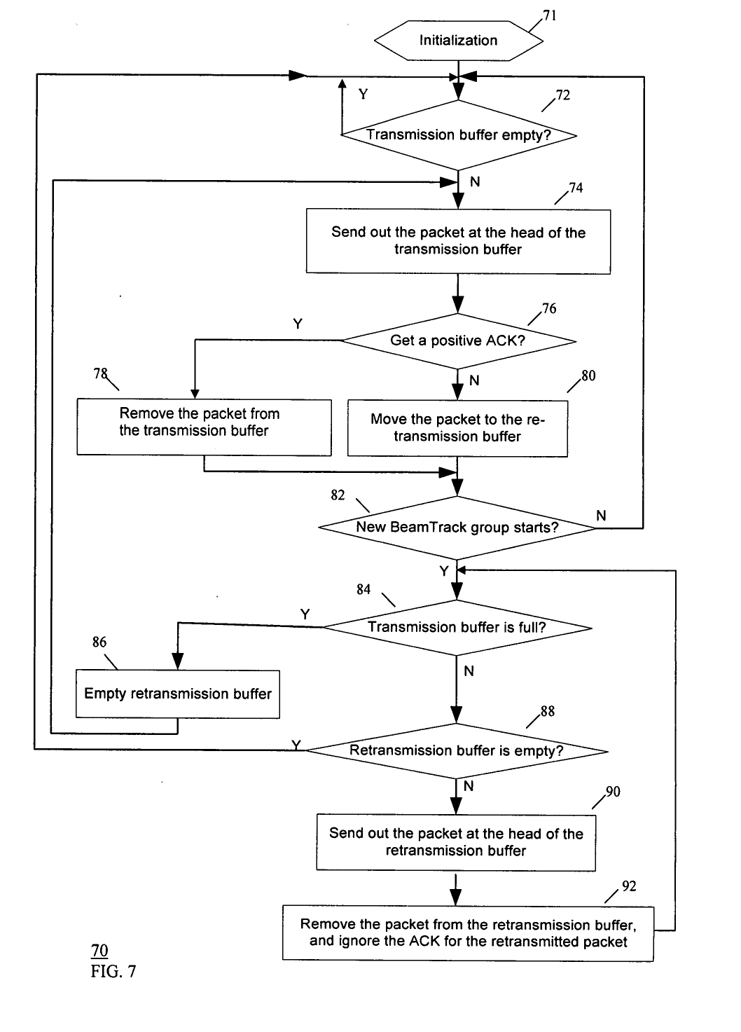

Referring to an example functional block diagram of the sender 14 in FIG. 5, uncompressed video stream information from a video source 30 is encoded and packetized into packets 20 by a Content Encryption and Packetization module 32. The data packets 20 are first placed in a transmission buffer 34 (e.g., First In, First Out (FIFO) queue memory) for transmission during a current BeamTrack Group (e.g., BeamTrack Group 25A in FIG. 4). Then under the control of a transmission scheduler 36, the data packets 20 are transmitted from the transmission buffer 34 to the receiver 12 (FIG. 6) via a transmission chain 38 (e.g., 60 GHz Rx Chain) over multiple transmit antennas 40. After transmission, each data packet 20 is moved from the transmission buffer 34 to a retransmission buffer 42 by the transmission scheduler 36, in anticipation of a possible retransmission, as indicated by a corresponding ACK packet 22 from the receiver 12. If the corresponding ACK packet 22 indicates that the packet 20 has been correctly received by the receiver 12, then that data packet 20 is removed from the retransmission buffer 42 by a transmission scheduler 36. The scheduling and buffer management operations of the example transmission scheduler 36 are described in more detail further below in conjunction with the flowchart of FIG. 7.

However, if the corresponding ACK packet 22 indicates that the packet 20 has been lost or incorrectly received by the receiver 12, then the scheduler 36 attempts to schedule retransmission of that data packet in the next BeamTrack Group (e.g., BeamTrack Group 25B in FIG. 4), as early as possible. After retransmission of a data packet to the receiver, that data packet is removed from the retransmission buffer 42, preferably immediately and without waiting for a corresponding ACK packet from the receiver.

FIG. 6 shows an example functional block diagram of the receiver 12. The transmitted signals from the sender 14 are received by receive antennas 50 and processed by the receiver chain 52 into data packets 20 that are placed in a receiving buffer 56 (e.g., FIFO queue) via a virtual path 54A. Any retransmitted data packets are also inserted in the receiving buffer 56 in proper order (as indicated by a virtual path 54B), to allow the receiver to recover information in a corresponding data packet received with errors. Each data packet 20 is then transferred out of the buffer 56 to the Stream Construction and Decryption module 58 for decryption and depacketization for stream construction. An Error Detection and Correction module 59 detects any errors in each packet (e.g., using a Cyclic Redundancy Code (CRC) check). Based on such error detection, an acknowledgement (ACK) Module 57 sends back positive acknowledgments to the sender for correctly received information and sends negative acknowledgements back to the sender for erroneous or lost information. The sender retransmits a correct copy of the negatively acknowledged information (i.e., erroneously received or lost information). Upon receiving retransmissions, the module 59 performs error correction using the transmitted information. The video stream then is provided to a video sink such as a TV 60.

As such, if one or multiple data packets 20 transmitted by the sender 14 in a current BeamTrack Group (e.g., BeamTrack Group 25A) are lost or have bit errors (as indicated by the negative ACK packets from the receiver 12), and if the transmission buffer for original data packets at the sender is not full, then re-transmission of the original data packets is conducted in a burst from the start of a new (next) BeamTrack Group (e.g., BeamTrack Group 25B). Otherwise, the sender 14 empties the re-transmission buffer, skips the re-transmission, and directly proceeds to further data packet transmission. Such an adaptive burst retransmission process according to a preferred embodiment of the present invention, strikes a balance between: (1) transmission reliability, by performing retransmissions, and (2) jitter and buffer size requirements, by skipping retransmissions.

Referring to the flowchart in FIG. 7, an example adaptive burst retransmission scheme at the sender 14 includes a scheduling and buffer management process 70 according to the present invention, including the following steps:
Step 71: Perform an initialization for enabling transmission packets on the high-rate channel, for example, to conduct beamforming.
Step 72: Determine if the transmission buffer is empty? If yes, go back to step 71, otherwise go to step 74.
Step 74: Send out a data packet at the head of the transmission buffer to the receiver by transmission over the HR channel, during a current BeamTrack Group.
Step 76: Receive an ACK packet from the receiver, and determine if the ACK packet is positive, indicating that the data packet was received at the receiver without error? If yes, go to step 78, otherwise, go to step 80
Step 78: Remove the data packet from the head of the transmission buffer. Since the sender receives a positive ACK indicating the packet was successfully received by the receiver, the sender removes the packet from the transmission buffer. Go to step 82.
Step 80: Move the packet from the head of the transmission buffer to the retransmission buffer.
Step 82: Determine if a new (next) BeamTrack Group is starting? If not, go back to step 72, otherwise, go to step 84.
Step 84: Determine if the transmission buffer is full? If yes, go to step 86, otherwise go to step 88.
Step 86: Empty the retransmission buffer, and go back to step 74.
Step 88: Determine if the retransmission buffer is empty? If yes, go back to step 72, otherwise, go to step 90.
Step 90: Send out a data packet at the head of the transmission buffer to the receiver by transmission over the HR channel, during the new BeamTrack Group.
Step 92: Remove the data packet from the head of the retransmission buffer (ignoring an ACK packet from the receiver for the retransmitted packet). Go back to step 84.

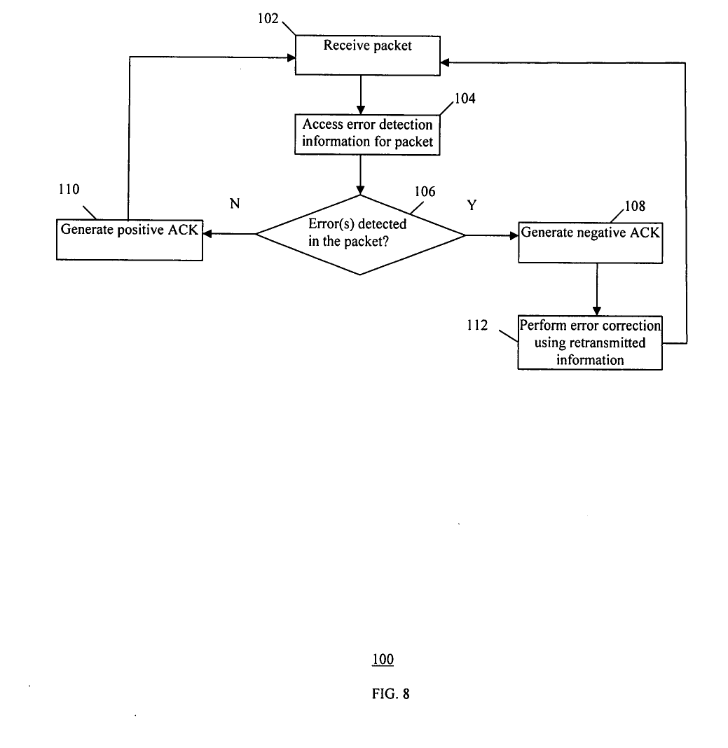

On the receiver side, as shown in FIG. 8, an example data packet processing 100 for each data packet proceeds by receiving a data packet (step 102), accessing error detection information for the packet (step 104), and checking for any errors in the data packet (step 106) such as by checking CRC information placed in the data packet by the sender. If one or more errors are detected, then the receiver generates a negative ACK for transmission to the sender in an ACK packet (step 110). If no errors are detected, then the receiver generates a positive ACK for transmission to the sender in an ACK packet (step 108). Based on the ACK information from the receiver, the sender retransmits a correct copy of information received at the receiver in error. Any retransmitted data packets from the sender are used by the receiver to recover information in a corresponding data packet received with errors (step 112). The process is repeated for a next received packet. The ACK packets are transmitted from the receiver to the sender over the low-rate channel. The ACK packets can also be sent to the sender over the high-rate channel. A data packet in the multiple data packets received by the receiver can include beamtracking information, wherein a corresponding acknowledgment packet from the receiver also includes beamtracking information.

Preferably, both the sender 14 and the receiver 12 have the buffer capacity to hold all data packets 20 within one BeamTrack Group. The required buffer size for each of the sender 14 and the receiver 12 can be calculated to be L*n*b/8 bytes, wherein L is the transmit duration for each data-ACK pair, n is the number of data-ACK pairs within one BeamTrack Group, and b is the effective channel bandwidth in Gbps (“*” indicates multiplication, and “/” indicates division). For example, if one data-ACK pair transmit duration is 100 microseconds, with 10 data-ACK pairs within one BeamTrack Group, and with the effective bandwidth of 3 Gbps, then the buffer size should be at least 375 Kbytes for each of the sender 14 and the receiver 12.

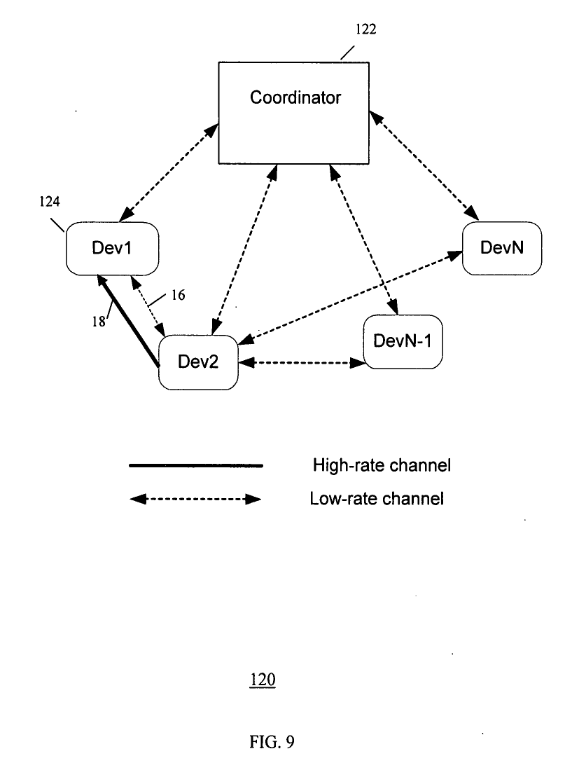

FIG. 9 shows a functional block diagram of another wireless network (communication system) 120 that implements uncompressed HD video transmission between wireless stations, according to an embodiment of the present invention. The network 120 includes a coordinator 122 and multiple wireless stations 124 (e.g., Dev1, . . . , DevN). The coordinator function for channel access according to the present invention is implemented by the stand-alone coordinator 122. In this example, the coordinator 122 provides channel access control for transfer of video information over the high-rate channel 18 between the Dev2 and Dev1 stations.

If data packet loss rate can be estimated and the HR channel 18 has enough bandwidth for retransmission, then in addition to the original data packet transmissions, the sender 14 schedules extra channel time for retransmission of lost/erroneous data packets. For example, if retransmission of 10% of the data packets can be supported, then the sender 14 allocates 10% more channel time for transmission of a video stream. Since extra time is allocated for retransmission, and enough buffer size is allowed, the example adaptive burst retransmission scheme according to the present invention can enhance transmission reliability.

As is known to those skilled in the art, the aforementioned example architectures described above, according to the present invention, can be implemented in many ways, such as program instructions for execution by a processor, as logic circuits, as an application specific integrated circuit, as firmware, etc.

The present invention has been described in considerable detail with reference to certain preferred versions thereof; however, other versions are possible. Therefore, the spirit and scope of the appended claims should not be limited to the description of the preferred versions contained herein.

What is claimed is:

1. A method of communication of video information between a sender and a receiver over a wireless channel, comprising the steps of:
inputting video information bits;
packetizing the video information bits into one or more data packets;
transmitting multiple data packets from the sender to the receiver over a wireless channel during a current time frame;
for each transmitted data packet, receiving a corresponding acknowledgment packet from the receiver; and
retransmitting a correct copy of information identified in the negatively acknowledged packets by burst retransmission during a next time frame comprising a Beamtrack group for transmission of further data packets from the sender to the receiver over a wireless channel.

2. The method of claim 1 wherein performing burst retransmission of the data packets further includes delaying retransmission of a correct copy of the negatively acknowledged data packets until said next time frame, and then retransmitting said correct copy of the negatively acknowledged data packets at the beginning of said next time frame in a burst sequence.

3. The method of claim 2 further comprising the steps of:
receiving each of the transmitted data packets at the receiver;
generating an acknowledgment packet for each data packet, wherein each acknowledgment packet includes a positive acknowledgement if a corresponding data packet was received without errors, or a negative acknowledgement if a corresponding data packet was lost or arrived at the receiver with errors; and
transmitting the acknowledgment packet from the receiver to the sender over a wireless channel.

4. The method of claim 1 wherein transmitting the data packets further includes transmitting the data packets from the sender to the receiver over a high-rate wireless channel.

5. The method of claim 4 wherein transmitting the acknowledgment packets from the receiver to the sender over a wireless channel further includes the step of the receiver transmitting a burst acknowledgment to the sender over a low-rate wireless channel.

6. The method of claim 5 wherein:
transmitting the multiple data packets from the sender to the receiver further comprises transmitting the multiple data packets from the sender to the receiver by directional transmission beams over a high-rate wireless channel; and
the receiver transmitting the burst acknowledgment to the sender over a low-rate channel further includes the steps of the receiver transmitting the burst acknowledgments to the sender by directional transmission over the low-rate wireless channel.

7. The method of claim 6 wherein a data packet in the multiple data packets includes beamtracking information.

8. The method of claim 7 wherein a corresponding acknowledgment packet further includes beamtracking information.

9. The method of claim 6 wherein the current time frame comprises a current beamtracking period and the next time frame comprises a next beamtracking period.

10. The method of claim 1 wherein the video information comprises uncompressed video information.

11. The method of claim 10 wherein the video information comprises uncompressed high-definition video information.

12. The method of claim 1 further comprising:
the receiver utilizing a retransmitted data packet to recover a lost or erroneous data packet.

13. The method of claim 1 further comprising the steps of:
placing a copy of each transmitted data packet in a retransmission buffer;
for each transmitted data packet, receiving a corresponding acknowledgment; and
removing the data packets with positive acknowledgments from the retransmission buffer;
wherein retransmitting a correct copy of negatively acknowledged packets includes delaying retransmission of the corresponding data packets remaining in the retransmission buffer until a next time frame for transmission of multiple data packets from the sender to the receiver, and during said next time frame, burst retransmitting the data packets from the retransmission buffer to the receiver over a wireless channel.

14. The method of claim 13 wherein the step of retransmitting the data packets further includes the step of retransmitting the data packets from the retransmission buffer to the receiver in a burst sequence at the beginning of said next time frame.

15. The method of claim 14 wherein the current time frame comprises a current beamtracking period and the next time frame comprises a next beamtracking period.

16. The method of claim 15 further comprising the step of:
the receiver utilizing a retransmitted data packet to recover a lost or erroneous data packet.

17. The method of claim 1 further comprising the steps of:
placing a copy of each transmitted data packet in a retransmission buffer; and
for each transmitted data packet, receiving a corresponding acknowledgment;
wherein retransmitting a correct copy of negatively acknowledged packets includes delaying retransmission of the corresponding data packets in the retransmission buffer until a next time frame for transmission of multiple data packets from the sender to the receiver, and during said next time frame, burst retransmitting the data packets from the retransmission buffer to the receiver over a wireless channel.

18. The method of claim 17 wherein the step of retransmitting the data packets further includes the step of retransmitting the data packets from the retransmission buffer to the receiver in a burst sequence at the beginning of said next time frame.

19. The method of claim 18 wherein the current time frame comprises a current beamtracking period and the next time frame comprises a next beamtracking period.

20. The method of claim 17 further comprising the step of:
at the beginning of said next time frame, emptying the remaining data packets from the retransmission buffer.

21. A wireless communication system for communication of video information, comprising:
a wireless transmitter including a packetizer configured for packetizing video information bits into one or more data packets, and a communication controller for transmitting multiple data packets over a wireless channel during a current time frame; and
a wireless receiver including a depacketizer configured for receiving the data packets from the transmitter, an error detection module configured to check each packet for errors, and an acknowledgment (ACK) module configured to generate an acknowledgment based on the error detection for each data packet to transmit to the sender for each received packet;
wherein the transmitter further includes a retransmitter configured to transmit a correct copy of the information identified in the negatively acknowledged packets, by burst retransmissions during a next time frame for transmission of further data packets from the transmitter to the receiver over a wireless channel.

22. The system of claim 21 wherein the retransmitter is further configured to delay retransmission of the correct copy of information for the negatively acknowledged data packets until said next time frame, and then retransmits a correct copy of the negatively acknowledged information at the beginning of said next time frame as a burst sequence.

23. The system of claim 22 wherein the acknowledgement module is further configured to generate an acknowledgment packet for each data packet, wherein each acknowledgment packet includes a positive acknowledgement if a corresponding data packet was received without errors, or a negative acknowledgement if a corresponding data packet was lost or arrived at the receiver with errors.

24. The system of claim 21 wherein the transmitter transmits the data packets to the receiver over a high-rate wireless channel.

25. The system of claim 24 wherein the receiver transmits the acknowledgment packets to the transmitter in a burst sequence over a low-rate wireless channel.

26. The system of claim 25 wherein:
the communication controller of the transmitter is further configured to transmit the multiple data packets to the receiver by directional transmission beams over the high-rate wireless channel; and
the acknowledgment module of the receiver is further configured to transmit the burst acknowledgments to the sender by directional transmission over the low-rate wireless channel.

27. The system of claim 26 wherein a data packet in the multiple data packets includes beamtracking information.

28. The system of claim 27 wherein a corresponding acknowledgment packet further includes beamtracking information.

29. The system of claim 26 wherein the current time frame comprises a current beamtracking period and the next time frame comprises a next beamtracking period.

30. The system of claim 21 wherein the video information comprises uncompressed video information.

31. The system of claim 30 wherein the video information comprises uncompressed high-definition video information.

32. The system of claim 21 wherein the receiver further includes an error correction module configured to utilize retransmitted information to recover lost or erroneously received information.

33. The system of claim 21 wherein:
the communication module of the transmitter is further configured to place a copy of each transmitted data packet in a retransmission buffer, and to remove the data packets with positive acknowledgments from the retransmission buffer; and
the retransmitter is further configured for retransmitting a correct copy of the negatively acknowledged packets by delaying retransmission of the corresponding data packets remaining in the retransmission buffer until a next time frame for transmission of multiple data packets from the sender to the receiver, and during said next time frame, burst retransmitting the data packets from the retransmission buffer to the receiver over a wireless channel.

34. The system of claim 33 wherein the retransmitter is further configured to retransmit said corresponding data packets from the retransmission buffer to the receiver in a burst sequence at the beginning of said next time frame.

35. The system of claim 34 wherein the current time frame comprises a current beamtracking period and the next time frame comprises a next beamtracking period.

36. The system of claim 21 wherein:
the communication controller of the transmitter is further configured to place a copy of each transmitted data packet in a retransmission buffer; and
the retransmitter is further configured for retransmitting a correct copy of information for the negatively acknowledged packets by delaying retransmission of the corresponding data packets in the retransmission buffer until a next time frame for transmission of multiple data packets from the sender to the receiver, and during said next time frame, burst retransmitting the data packets from the retransmission buffer to the receiver over a wireless channel.

37. The system of claim 36 wherein the retransmitter is further configured for retransmitting the data packets by retransmitting the data packets from the retransmission buffer to the receiver in a burst sequence at the beginning of said next time frame.

38. The system of claim 37 wherein the current time frame comprises a current beamtracking period and the next time frame comprises a next beamtracking period.

39. The system of claim 36 wherein the communication controller is further configured such that at the beginning of said next time frame, the communication controller empties the remaining data packets from the retransmission buffer.

40. A wireless transmitter for communication of video information over wireless channels, comprising:
a packetizer configured for packetizing video information bits into one or more data packets;
a communication controller for transmitting multiple data packets over a wireless channel to a receiver during a current time frame; and
a retransmitter configured to transmit a correct copy of information identified in the negatively acknowledged packets from a receiver, by burst retransmissions during a next time frame for transmission of further data packets from the transmitter over a wireless channel.

41. The transmitter of claim 40 wherein the retransmitter is further configured to delay retransmission of a correct copy of information for the negatively acknowledged data packets until said next time frame, and then retransmits a correct copy of the negatively acknowledged information at the beginning of said next time frame as a burst sequence.

42. The transmitter of claim 40 wherein the communication controller transmits the data packets to the receiver over a high-rate wireless channel.

43. The transmitter of claim 40 wherein the communication controller of the transmitter is further configured to transmit the multiple data packets to the receiver by directional transmission beams over a high-rate wireless channel.

44. The transmitter of claim 43 wherein a data packet in the multiple data packets includes beamtracking information.

45. The transmitter of claim 43 wherein the current time frame comprises a current beamtracking period and the next time frame comprises a next beamtracking period.

46. The transmitter of claim 40 wherein:
the communication module of the transmitter is further configured to place a copy of each transmitted data packet in a retransmission buffer, and to remove the data packets with positive acknowledgments from the retransmission buffer; and
the retransmitter is further configured for retransmitting a correct copy of the negatively acknowledged packets by delaying retransmission of the corresponding data packets remaining in the retransmission buffer until a next time frame for transmission of multiple data packets from the transmitter to the receiver, and during said next time frame, burst retransmitting the data packets from the retransmission buffer to the receiver over a wireless channel.

47. The transmitter of claim 46 wherein the retransmitter is further configured to retransmit said corresponding data packets from the retransmission buffer to the receiver in a burst sequence at the beginning of said next time frame.

48. The transmitter of claim 47 wherein the current time frame comprises a current beamtracking period and the next time frame comprises a next beamtracking period.

49. The transmitter of claim 40 wherein:
the communication controller of the transmitter is further configured to place a copy of each transmitted data packet in a retransmission buffer; and
the retransmitter is further configured for retransmitting a correct copy of information for the negatively acknowledged packets by delaying retransmission of the corresponding data packets in the retransmission buffer until a next time frame for transmission of multiple data packets from the transmitter to the receiver, and during said next time frame, burst retransmitting the data packets from the retransmission buffer to the receiver over a wireless channel.

50. The transmitter of claim 40 wherein the retransmitter is further configured for retransmitting data packets by retransmitting the data packets from the retransmission buffer to the receiver in a burst sequence at the beginning of said next time frame.

51. The transmitter of claim 50 wherein the current time frame comprises a current beamtracking period and the next time frame comprises a next beamtracking period.

52. The transmitter of claim 51 wherein the communication controller is further configured such that at the beginning of said next time frame, the communication controller empties the remaining data packets from the retransmission buffer.

53. A wireless receiver for communication of video information over wireless channels, comprising:
a communication module configured for receiving data packets from a transmitter over a wireless channel during a current time frame, the packets including video information bits;
a depacketizer configured for depacketizing the information bits in the packets;
an error detection module configured to check each packet for errors; and
an acknowledgment (ACK) module configured to generate an acknowledgment based on the error detection for each data packet to transmit to the transmitter for each received packet;
wherein the communication module is further configured to receive a burst of retransmitted packets from the transmitter for the negatively acknowledged packets during a next time frame.

54. The receiver of claim 53 wherein said next frame comprises a time frame for transmission of further packets from the transmitter.

55. The receiver of claim 54 wherein the acknowledgement module is further configured to generate an acknowledgment packet for each data packet, wherein each acknowledgment packet includes a positive acknowledgement if a corresponding data packet was received without errors, or a negative acknowledgement if a corresponding data packet was lost or arrived at the receiver with errors.

56. The receiver of claim 55 further comprising an error correction module configured to utilize retransmitted information to recover lost or erroneously received information.

57. The receiver of claim 53 wherein the communication module of the receiver is further configured to transmit the acknowledgment packets to the transmitter in a burst sequence over a low-rate wireless channel.

58. The receiver of claim 57 wherein the acknowledgement module is further configured to transmit the burst acknowledgments to the sender by directional transmission over the low-rate wireless channel.

59. The receiver of claim 58 wherein a received packet includes beamtracking information and the acknowledgement module is further configured to include beamtracking information in a corresponding acknowledgment packet.
